(19) United States
(12) Patent Application Publication
(10) Pub. No.: US 2005/0186471 A1
(43) Pub. Date: Aug. 25, 2005

(54) Intrinsically-safe battery power supply for underground mining

(75) Inventors: Jens Titschert, Lunen (DE); Norbert Schwarz, Recklinghausen (DE); Jorg Wagener, Lunen (DE)

Correspondence Address: Mark E. Bandy, Esq.;Fay, Sharpe, Fagan, Minnich & McKee, LLP, 1100 Superior Avenue, Seventh Floor, Cleveland, OH, 44114-2518, US

(73) Assignee: DBT Automation GmbH

(21) Appl. No.: 11/042,371

(22) Filed: Jan. 25, 2005

(30) Foreign Application Priority Data
Feb. 19, 2004 (DE) 10 2004 008 569.2

(51) Int. Cl. H01M 2/02; H01M 10/46

(52) U.S. Cl. 429/175; 429/61; 429/156

(57) ABSTRACT

An intrinsically-safe battery power supply for electrical equipment in underground mining and in other areas exposed to the danger of explosion is disclosed. The power supply includes at least one chargeable storage battery cell disposed in a battery housing. At least one storage battery cell comprises a chargeable lithium storage battery cell and the battery housing is configured to be pressure-resistant and to receive all lithium storage battery cells in a manner so as to be protected from explosion. The pressure-resistant configuration of the battery housing enables the use of lithium storage battery cells in underground mining. Once the battery power supply fulfils all requirements of ignition protection certification, even modern types of lithium storage battery cell can be disposed in the battery housing.

### CROSS REFERENCE TO RELATED APPLICATIONS

This application claims priority from German patent application No. 10 2004 008 569.2 filed Feb. 19, 2004.

### FIELD OF THE INVENTION

The present invention relates to an intrinsically-safe battery power supply for electrical equipment in underground mining or in other areas exposed to the danger of explosion or firedamp ignition, with at least one chargeable storage battery cell disposed in a battery housing.

### BACKGROUND OF THE INVENTION

In underground mining and in other areas exposed to the danger of explosion or firedamp ignition, there is a need for the supply, independently of a power supply network, of sufficient intrinsically-safe voltage to electrical equipment. In underground mining, for example, a chargeable battery power supply that uses Nickel Cadmium storage battery cells (NiCad accumulators) is utilized for support shield controllers, remote controllers, measuring equipment in poorly-accessible areas and other electrical equipment. The NiCad storage batteries have a low charge capacity and poor recharging characteristics since, due to the so-called “memory effect”, reduced charging capacity results if the NiCad storage battery was not completely discharged before being recharged. Due to the low charging capacity of NiCad accumulators, a great number of spare storage batteries is required in underground mining that have to be taken underground and temporarily stored there. Recharging of the NiCad storage batteries takes place exclusively on the surface, wherein the transportation of charged and discharged storage batteries (accumulators) also represents a logistical problem.

In underground mining, power supply sources may only be used if they are certified for use in areas that are exposed to the danger of explosion and correspond with the ignition protection legislation (e.g. ATEX, IEC, Eex etc.) that is applicable in the place of utilization. Here, each approval examination is associated with substantial cost. Hence for reasons of cost, it is hardly possible to have repeatedly modified storage battery cells re-certified for use in areas that are exposed to the danger of explosion.

For this reason, intrinsically-safe battery power supplies are often used in underground mining that do not technologically correspond to the latest state of the art and whose basic structure is disclosed in DE 30 15 751 C2 from 1980. The battery power supplies comprise NiCad storage battery cells that are disposed in a battery housing and electronics, that are not intrinsically-safe, cast in silicon rubber and embedded in an electronics housing, wherein the two housings are inserted together in a master housing. Alternatively, the storage battery cells can be cast together with a necessary protection circuit to comply with the ignition protection class that is applicable to gain certification. Repair of such battery power supplies, especially the replacement of storage batteries within such battery power supplies, is not possible without unacceptable cost.

Outside the field of underground mining, especially in the field of the communications and entertainment industries, lithium storage battery cells (lithium accumulators) are increasingly replacing the lead-containing batteries and NiCad storage battery cells that have previously been used. Fundamental efforts are therefore being made to be able to use lithium storage battery cells in other areas of technology, as can be seen, for example, in U.S. Pat. No. 5,376,475 that relates to chargeable, aqueous lithium hydrogen ion batteries. There are, however, substantial safety problems associated with the use of lithium storage battery cells regarding possible explosion of the storage battery cells, as can be seen in U.S. Pat. No. 5,376,475. Up to now, lithium storage battery cells have therefore not been used in underground mining and other areas that are exposed to the danger of explosion.

### BRIEF DESCRIPTION

An object of the present invention is to provide an intrinsically-safe battery power supply for electrical equipment that can be used in underground mining and other areas that are exposed to the danger of explosion, that can comprise storage battery cells that correspond even with the latest technical state of development and for which a certification examination for the respective ignition protection class can be provided at minimum or no additional cost.

The object is achieved according to the invention in that at least one storage battery cell comprises a chargeable lithium storage battery cell (lithium accumulator) and that the battery housing is configured to receive all lithium storage battery cells and to be explosion-proof and pressure resistant. In accordance with the invention, the intrinsically-safe battery power supply therefore comprises a battery housing that is configured to be pressure-resistant in such a way that all lithium storage battery cells disposed therein do not represent a danger of explosion to their environment. In the case of a battery power supply according to the invention, only the pressure-resistant battery housing will be subjected to certification for the respective ignition protection class and the specified internal resistance against pressure need only be equivalent to an internal pressure that could possible be generated by an explosion of a lithium storage battery cell. Therefore, exchanging the actual lithium storage battery cells that are disposed in the certified, pressure-resistant battery housing does not cause the certification of the battery power supply to be invalidated. Due to the pressure-resistant configuration of the battery housing, it will now be possible to use lithium storage battery cells in underground mining. These are not susceptible to a noticeable “memory effect”, they have a substantially longer service life and with a substantially higher charging capacity, they also allow a significantly longer operating phase underground.

### BRIEF DESCRIPTION OF THE DRAWINGS

FIG. 1 is a schematic illustration of a preferred embodiment battery power supply for underground mining in accordance with the present invention.

### DETAILED DESCRIPTION

In a preferred embodiment, the battery housing is pressure-resistant and gas-tight. It is also preferred that the battery housing is configured to be resistant to electrolyte. The aforementioned measures ensure that different storage battery technologies can be used for the lithium storage batteries without requiring renewed certification for the ignition protection class. This is especially advantageous in that smaller alterations to the cell structure, to the actual composition of the lithium storage battery cell and to the housing of the lithium storage battery cell do not require renewed ignition protection certification. New storage battery technology can therefore be integrated immediately into the intrinsically-safe battery power supply according to the invention.

The lithium storage battery cells can basically function in accordance with any possible storage battery or accumulator technology. In a preferred embodiment, these can be lithium ion storage battery cells, lithium polymer storage battery cells or lithium storage battery cells with a fluid electrolyte. By way of example, reference is made to U.S. Pat. No. 5,376,475, herein incorporated by reference.

In order to guarantee electrically faultless functioning of lithium storage battery cells that are installed in pressure-resistant battery housings, independent of the technological structure of the lithium storage battery cells, it is preferred that a preferably intrinsically-safe circuit is disposed together with the lithium storage battery cells in the battery housing to limit overcurrent and/or overvoltage. By use of this circuit, the current and the voltage that is present at the contact terminals or contacts of the pressure-resistant battery housing can always be limited at the storage battery side to specified maximum electrical parameters, independent of the type of storage battery used.

In another embodiment of the present invention, a charging circuit is also disposed in the battery housing in addition to the storage batteries, so that the lithium storage battery cells can be charged via a charging plug that is connected to the underground, intrinsically-safe power supply network. In a preferred embodiment, however, the battery housing is housed in a master housing or is provided with an enveloping or additional housing so that the intrinsically-safe battery power supply can be substantially constructed in accordance with a modular principle in that lithium storage battery cells, encapsulated so as to be explosion-proof, are disposed in the pressure-resistant battery housing and can be combined with all necessary or desired circuits in enveloping or master housings. In addition, with this embodiment the battery housing can comprise a lightweight, pressure-resistant material such as a light metal, in particular an aluminum sheet, while the master housing is formed from a suitable plastic.

The battery power supply can preferably include a charging circuit, in particular an intrinsically-safe charging circuit being disposed within the master housing and outside of the battery housing. Here, it is basically advantageous if the charging circuit comprises control electronics to control the charging current and charging voltage for the lithium storage battery cells. With regard to the embodiment according to the invention with the master housing, it is especially advantageous if a charging socket is attached to the master housing in which a charging plug that can be supplied with current from the underground power supply network can be inserted. It is also preferred that the charging and current consumption sockets and/or operating switch and/or on/off switch can be attached to the master housing. With this embodiment, it is also preferred that an external protection circuit that is necessary for operation can be disposed within the master housing and outside of the battery housing. The charging circuit and the protection circuit can then expediently be electrically incorporated between electrical contact points or connection lines on the pressure-resistant battery housing for the lithium storage battery cells and the charging and current consumption sockets.

In the case of the especially preferred embodiment, the lithium storage battery cells in the pressure-resistant battery housing together supply an internal operating voltage that is greater than the external, intrinsically safe operating voltage that can be applied to the electrical equipment. In order to obtain a sufficiently high voltage potential, several lithium storage battery cells can be disposed in series. In order to carry out charging with the intrinsically-safe underground power supply network in spite of the higher internal voltage potential without causing an excess voltage at the end consumer, the charging circuit and/or the current limiting circuit are expediently provided with direct current transformers to transform the voltage potentials to the corresponding higher internal operating voltage or lower external operating voltage. DC/DC transformers can especially be used for this transformation.

Other advantages and embodiments of the invention can be seen in the embodiment example represented in the drawing.

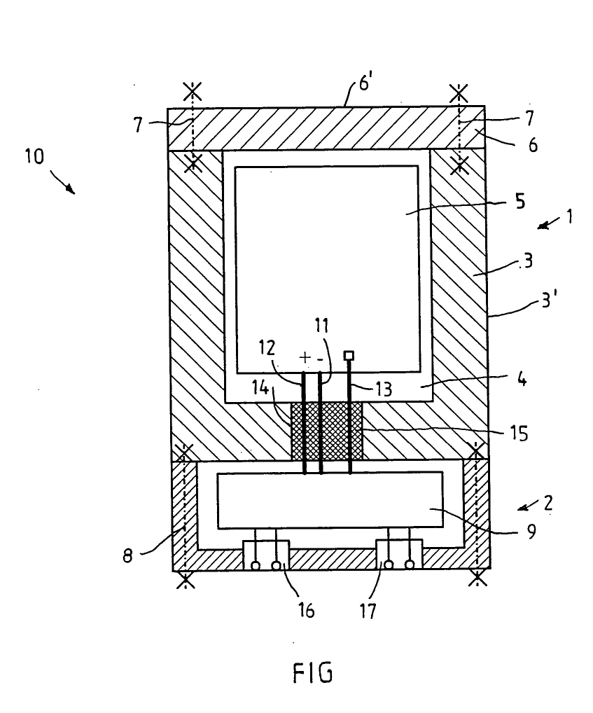

FIG. 1 shows a battery power supply for underground mining, indicated in its entirety with reference number 10. In the illustrated embodiment example, the battery power supply comprises a pressure resistant battery housing 1 and an enveloping or additional housing 2. The battery housing 1 comprises a battery box 3, in the receiving space 4 of which is disposed a lithium ion storage battery cell 5, preferably comprising several lithium ion storage battery cells connected in series. The battery box 3 is closed, for example by use of several bolted connections 7 indicated in the drawing, in a pressure resistant manner by a battery box lid 6, through which the lithium ion storage battery cells can be installed in the receiving space 4. The strengths of the surrounding walls of the battery box 3 and the lid 6 and the bolted connections 7 are configured in such a way that the battery housing 1 remains closed in a pressure proof and gas-tight manner even if an explosion with a specified maximum explosion pressure occurs in the interior space 4. Here, the resistance to pressure of the battery housing 1 is adapted to the maximum burst pressure that is to be expected in the case of lithium storage battery cells 5. The material of the battery housing 3 and the lid 6, and the seals disposed between the two, is selected so that the battery housing 1 is gas-tight and resistant to those electrolytes that are used by chargeable lithium storage battery cells 5 for the movement and conduction of ions in order to provide an energy supply with the lithium storage battery cell or cells 5 for intrinsically safe equipment in underground mining.

In the illustrated embodiment example, the enveloping housing 2 is bolted on a front side of the battery box 3, opposite the lid 6, by means of a bolted connection 8. The embodiment example only serves to schematically explain the structure of the invention, since in an especially preferred embodiment the battery box 3 and its lid 6 comprise a light metal such as aluminum in particular, while the enveloping housing 2 comprises a suitable plastic and completely encloses the battery box and the lid 6, so that the battery power supply 10 does not have any metallic surfaces. In the illustrated embodiment example, on the other hand, if comprising an aluminum plate, the surface 3′ of the battery box 3 and the surface 6′ of the lid 6 could be provided with a plastic coating to achieve the same effect.

A multi-function circuit is shown schematically with a circuit board 9 in the enveloping housing 2. All circuits on the circuit board 9 are preferably intrinsically safe. The circuit 9 is connected with the corresponding contact points on the lithium storage battery cell 5 via electrical connections 11, 12 or connection lines and at least one sensor line 13 for a temperature sensor. The lines 11, 12, 13 penetrate an opening 14 in the base of the battery box 3, wherein the opening 14 is configured as a pressure-resistant opening 15 and is closed in a suitable manner by means of installed parts, adhesives and/or stability supports. On the circuit board 9 there is both an intrinsically-safe charging circuit and an intrinsically-safe protection circuit disposed. The protection circuit is switched electrically between the lines 11, 12, 13 and a schematically-illustrated current consumption socket 16 that is certified for use in underground mining, to which a consumer can be connected. A charging socket 17 is also disposed in the enveloping housing 2 in addition to the current consumption socket 16. The circuit board 9 contains a charging circuit that is integrated between the charging socket 17 and the connection lines 11, 12 for the lithium storage battery cell 5, so that the lithium storage battery cell of the intrinsically-safe battery power supply 10 can be recharged underground via a charging plug, not illustrated, that is connected to the underground power supply network.

In a preferred embodiment the lithium storage battery cells 5 have a voltage potential at both connection terminals 11, 12 that is greater than the voltage potential required for operation of controllers, extraction controllers, measuring equipment and other, portable, electrical equipment without the possibility of connection to the underground energy supply network. Both the charging and the protection circuit on the circuit board 9 then have direct current transformers (DC/DC transformers) to transform the internal operating voltage of the storage battery cells 5 to the external operating voltage required at the current consumption socket 16 or to transform the operating voltage at the charging socket 17 to the required higher operating voltage.

The figure does not show that an additional circuit to limit overcurrent and/or overvoltage can be disposed in the interior space 4 of the battery housing 1, via which the maximum value of the voltage supplied by the lithium storage battery cells 5 can be limited. In addition, the charging circuit can comprise control electronics to control the charging current and voltage for the lithium storage battery cells.

Numerous modifications will be apparent to the person skilled in the art which modifications should fall within the scope of protection of the appended claims. The illustrated embodiment example is purely schematic and should not limit the scope of protection of the appended claims.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An intrinsically safe battery power supply for electrical equipment in underground mining and in other areas exposed to the danger of explosion or firedamp ignition, the battery power supply comprising at least one chargeable storage battery cell disposed in a battery housing, wherein at least one storage battery cell comprises a chargeable lithium storage battery cell and the battery housing is pressure resistant for receipt of all lithium storage battery cells in a manner so as to be protected from explosion.

2. The battery power supply according to claim 1, wherein the battery housing is gas-tight.

3. The battery power supply according to claim 1, wherein the battery housing is resistant to electrolyte.

4. The battery power supply according to claim 1 wherein the lithium storage battery cells comprise at least one of lithium ion storage battery cells and lithium polymer storage battery cells.

5. The battery power supply according to claim 4, wherein the lithium storage battery cells comprise a fluid electrolyte.

6. The battery power supply according to claim 1 further comprising a circuit that is disposed in the battery housing together with the storage battery cells to limit overcurrent and/or overvoltage.

7. The battery power supply according to claim 1 further comprising a charging circuit disposed in the battery housing.

8. The battery power supply according to claim 1, wherein the battery housing includes and is housed in a master or additional housing.

9. The battery power supply according to claim 8, wherein the battery housing comprises a lightweight, stress-resistant material, and the master housing or additional housing comprises a plastic.

10. The battery power supply according to claim 8, further comprising an intrinsically safe charging circuit disposed within the master or additional housing and outside of the battery housing.

11. The battery power supply according to claim 9, further comprising an intrinsically safe charging circuit disposed within the master or additional housing and outside of the battery housing.

12. The battery power supply according to claim 10, wherein the charging circuit includes control electronics to control the charging current and charging voltage for the lithium storage battery cells.

13. The battery power supply according to claim 11, wherein the charging circuit includes control electronics to control the charging current and charging voltage for the lithium storage battery cells.

14. The battery power supply according to claim 8, further comprising a charging socket, in which a charging plug that can be supplied with current from an underground power supply network can be inserted, is attached to the master or additional housing.

15. The battery power supply according to claim 8, further comprising charging and current consumption sockets attached to the master or additional housing.

16. The battery power supply according to claim 8, further comprising an operating switch attached to the master or additional housing.

17. The battery power supply according to claim 8, further comprising an on/off switch attached to the master or additional housing.

18. The battery power supply according to claim 8, further comprising an external protection circuit disposed within the master or additional housing and outside of the battery housing.

19. The battery power supply according to claim 18, further comprising a charging circuit and charging and current consumption sockets, wherein the charging circuit and the protection circuit are electrically incorporated between electrical contact points on the battery housing for the lithium storage battery cells and the charging and current consumption sockets.

20. The battery power supply according to claim 1, wherein the lithium storage battery cells in the battery housing together supply an internal operating voltage that is greater than the external, intrinsically-safe operating voltage that can be applied to the electrical equipment.

21. The battery power supply according to claim 20, further comprising at least one of a charging circuit and a current limiting circuit, wherein the charging circuit and/or the current limiting circuit are provided with direct current transformers to transform the voltage potentials.

22. The battery power supply according to claim 10, wherein the lithium storage battery cells are connected with the charging circuit via a pressure-resistant opening in the battery housing.

23. A battery power supply adapted for underground mining, the battery power supply comprising:
a battery housing having a surrounding wall defining an interior space accessible through an open end, the housing including a lid releasably affixed to the battery housing;
a battery disposed in the interior space;
an additional housing secured to the battery housing, the additional housing defining a hollow region; and
a circuit board disposed in the additional housing, the circuit board being in electrical communication with the battery by use of electrical connections extending through an opening defined in the battery housing;
wherein the surrounding wall, the lid, and affixment therebetween are such that the battery housing remains closed in a pressure proof and gas-tight manner in the event that the battery explodes.

24. The battery power supply of claim 23 wherein the battery housing and the lid are formed from aluminum.

25. The battery power supply of claim 23 wherein the battery is a lithium battery.

26. An intrinsically safe battery power supply adapted for use in underground mining and other areas exposed to danger of explosion or firedamp ignition, the battery power supply comprising:
a battery housing defining an interior region accessible through a first opening in the housing;
a lid sealingly disposed over the first opening defined in the battery housing;
at least one lithium battery disposed in the interior region of the battery housing the at least one lithium battery having a specified maximum explosion pressure;
a secondary housing secured to the battery housing and defining an interior region;
a circuit board and circuitry disposed in the interior region of the secondary housing and in electrical communication with the at least one lithium battery;
wherein the battery housing and the lid remain closed in a pressure-proof and gas-tight manner even if an explosion with the specified maximum explosion pressure occurs in the interior region of the battery housing.
